(19) United States
(12) Patent Application Publication
(10) Pub. No.: US 2007/0154113 A1
(43) Pub. Date: Jul. 5, 2007

(54) SYSTEM AND METHOD FOR IMAGE MEASURING

(75) Inventors: CHIH-KUANG CHANG, Taipei Hsien (TW); SEN ZHANG, Shenzhen (CN); XI-LIANG FENG, Shenzhen (CN); LI JIANG, Shenzhen (CN); HUA-WEI YANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/555,251

(22) Filed: Oct. 31, 2006

(30) Foreign Application Priority Data
Dec. 30, 2005 (CN) 200510121412.1

(51) Int. Cl. G06K 9/36

(52) U.S. Cl. 382/286

(57) ABSTRACT

A method for image measuring is provided. The method includes the steps of: providing a workpiece on an image measuring instrument (20) connected to a computer (10); receiving a coordinate position of a zoom lens (220) on the image measuring instrument; compensating errors of the coordinate position; adjust the focal lengths and positioning of the zoom lens, and receiving an image of the workpiece; processing the image of the workpiece; mapping/computing coordinate systems and structural patterns of the image, and obtaining structural data of the image; and outputting the structural data of the image. A related system is also provided.

### BACKGROUND OF THE INVENTION

1. Field of the Invention

The present invention is generally related to systems and methods of measurement especially to systems and methods for image measuring.

2. Description of Related Art

Nowadays, factors that make a manufacturing company successful include marketing, information management, quality management, product development, and technological innovations. Wherein, the most important factors of success is related to quality issues: implementation and development of quality control system, ensuring stable quality and product safety, strict quality control of raw materials, and ensuring the quality of production processes and services.

Before a type of workpiece is mass produced, at least one sample of the type of workpiece needs to be measured so as to inspect the quality of the workpiece sample. But the usual manual method for measuring is inefficient and inaccurate. With the development of information technology, computers are now used for image measuring together with a measuring instrument.

however the current method for image measuring by using a computer associated with a measuring instrument has disadvantages. For example, it is necessary to repeat the same operation when measuring the same workpiece, and the measurement results cannot be visually reflected.

Accordingly, what is needed is a system and method for image measuring, which can edit program code automatically for finishing the same measurement, and integrate the structural patterns of a image with structural patterns display for reflecting the measurement results visually.

### SUMMARY OF THE INVENTION

One preferred embodiment provides a system for image measuring. The system includes a data receiving module, an accuracy compensating module, an image processing module, a computing module, and an outputting module. The data receiving module is configured for receiving a coordinate position of a zoom lens on an image measuring instrument connected to a computer, and for receiving an image of a workpiece on the image measuring instrument. The accuracy compensating module is configured for compensating errors of the coordinate position of the zoom lens. The image processing module is configured for processing the image of the workpiece. The computing module is configured for mapping/computing coordinate systems and structural patterns of the image, and obtaining structural data of the image. The outputting module is configured for outputting the structural data of the image.

Another preferred embodiment provides a method for image measuring. The method includes the steps of: providing a workpiece on an image measuring instrument connected to a computer; receiving a coordinate position of a zoom lens on the image measuring instrument; compensating errors of the coordinate position; adjust the focal lengths and positioning of the zoom lens, and receiving an image of the workpiece; processing the image of the workpiece; mapping/computing coordinate systems and structural patterns of the image, and obtaining structural data of the image; and outputting the structural data of the image.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of hardware configuration of a system for image measuring in accordance with one preferred embodiment;

FIG. 2 is a schematic diagram of function modules of an image measuring unit in FIG. 1;

FIG. 3 is a flowchart of a method for preparing image measuring in accordance with one preferred embodiment; and

FIG. 4 is a flowchart of a method for image measuring in accordance with one preferred embodiment.

### DETAILED DESCRIPTION OF THE INVENTION

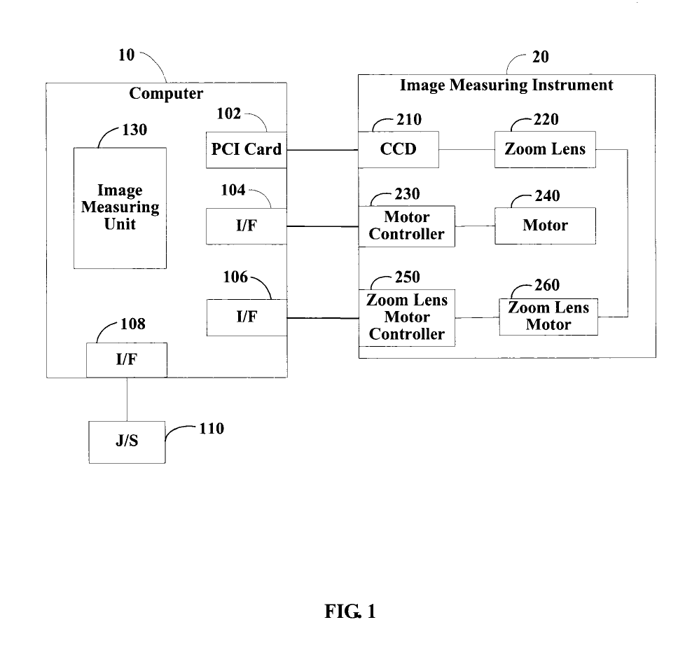

FIG. 1 is a schematic diagram of hardware configuration of a system for image measuring in accordance with one preferred embodiment. The hardware configuration may typically include a computer 10, an image measuring instrument 20, and a joystick box (hereinafter referred to as “J/S”) 110. The image measuring instrument 20 may typically include a charge coupled device (CCD) 210, a zoom lens 220, a motor controller 230, a motor 240, a zoom lens motor controller 250, and a zoom lens motor 260. The computer 10 may be an IBM architecture personal computer (PC), or any other type of computer. Typically, the computer 10 may include an image measuring unit 130, a peripheral component interconnect (PCI) card 102, a first interface (hereinafter referred to as “I/F”) 104, a second I/F 106, and a third I/F 108. The computer 100 may further include other devices, such as a central processing unit (CPU), a memory, a monitor, a mouse, and a keyboard. The zoom lens 220 is connected with the PCI card 102 via the CCD 210. The motor 240 is connected with the first I/F 104 via the motor controller 230. The zoom lens motor 260 is connected with the second I/F 106 via the zoom lens motor controller 250. The J/S 110 is connected with the third I/F 108. Wherein, the first I/F 104 may be a serial port, and the second I/F 106 and third I/F 108 may be a universal serial bus (USB) port respectively.

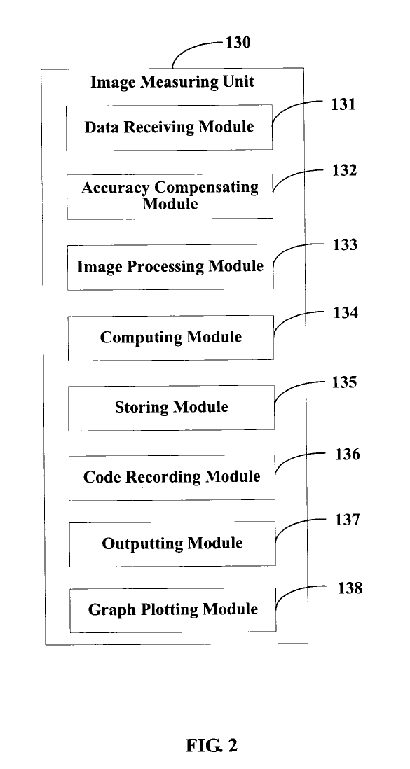

The J/S 110 connected to the third I/F 108 is configured for sending move instructions that include positioning and speeds to the image measuring unit 130. The image measuring unit 130 that runs in the computer 10 is configured for receiving move instructions from the J/S 110 and images from the image measuring instrument 20, and controlling various components of the image measuring instrument 20 to measure a size and a shape of a workpiece on the image measuring instrument 20. The image measuring unit 130 includes several modules that will be detailedly described in FIG. 2.

The CCD 210 is configured for capturing an image of the workpiece on the image measuring instrument 20 that is focused by the zoom lens 220, and for transmitting the image to the image measuring unit 130 via the PCI card 102.

The motor controller 230 is configured for receiving the move instructions that is outputted from the image measuring unit 130 to adjust a positioning of the zoom lens 220 via the motor 240.

The zoom lens motor controller 250 is configured for receiving the zoom instructions that is outputted from the image measuring unit 130 to adjust a focal length of the zoom lens via the zoom lens motor 260.

FIG. 2 is a schematic diagram of function modules of the image measuring unit 130. The image measuring unit 130 mainly includes a data receiving module 131, an accuracy compensating module 132, an image processing module 133, a computing module 134, a storing module 135, a code recording module 136, an outputting module 137, and a graph plotting module 138.

The data receiving module 131 is configured for receiving a coordinate position of the zoom lens 220 via the first I/F 104, and for receiving the image of the workpiece on the image measuring instrument 20 via the PCI card 102.

The accuracy compensating module 132 is configured for compensating errors of the coordinate of the zoom lens 220. For example, if the image measuring instrument 20 has coordinate errors of 0.5 on an X-axis, when the coordinate position of the zoom lens 220 that is received by the data receiving module 131 is (50,0,0), the accuracy compensating module 131 compensates the coordinate position to (50.5,0,0).

The image processing module 133 is configured for processing the image of the workpiece that is received by the data receiving module 131. Specifically, the image processing module 133 identifies outlines of the image via an edge tool, analyzes the structural patterns of the outlines that include spot, line, circle, and plane, filters the outlines smoothly via a filter tool, and computes a sharpness of the image. Wherein, the process of computing the sharpness is by selecting two different structural patterns of the image, reading the coordinates of the two different structural patterns, and computing a contrast between the two. If the contrast between the two exceeds a predetermined contrast value, which indicates a high sharpness of the image, the computing module 134 can continue the following measurement; otherwise, if the contrast between the two does not exceeds the predetermined contrast value, which indicates a low sharpness of the image, it is necessary to adjust the image for recomputing sharpness.

The computing module 134 is configured for mapping/computing coordinate systems and structural patterns of the image, and obtaining structural data of the image. Wherein, the process of computing coordinate systems is by using a mechanical coordinate system of the image measuring instrument as a reference coordinate grid, and mapping coordinate systems selected by an operator according to the coordinate grid. The process of computing structural patterns of the image includes computing spatial locations of structural patterns of the image, and computing relative coordinates between two different structural patterns of the image. Wherein, the structural data include coordinates of the image, a geometrical shape of the image, and a unit vector of the image.

The storing module 135 is configured for storing the structural data of the image in a program file.

The code recording module 136 is configured for recording measuring configurations with corresponding procedure codes while measuring the workpiece. Wherein, the code recording module 136 includes generating procedure codes of measuring procedures, compiling the procedure codes, and executing the procedure codes after compiling. The measuring configurations include a positioning coordinates of the zoom lens 220, a positioning speed of the zoom lens 220, and other related operational information such as an edge tool, a focus tool, measuring elements, constructive elements, and coordinates.

The outputting module 137 is configured for outputting the structural data of the image.

The graph plotting module 138 is configured for plotting a structural graph of the workpiece based on the structural data of the image. Wherein, the structural graph of the workpiece may include coordinates of the image, structural patterns of the image, and identifications of structural patterns of the image.

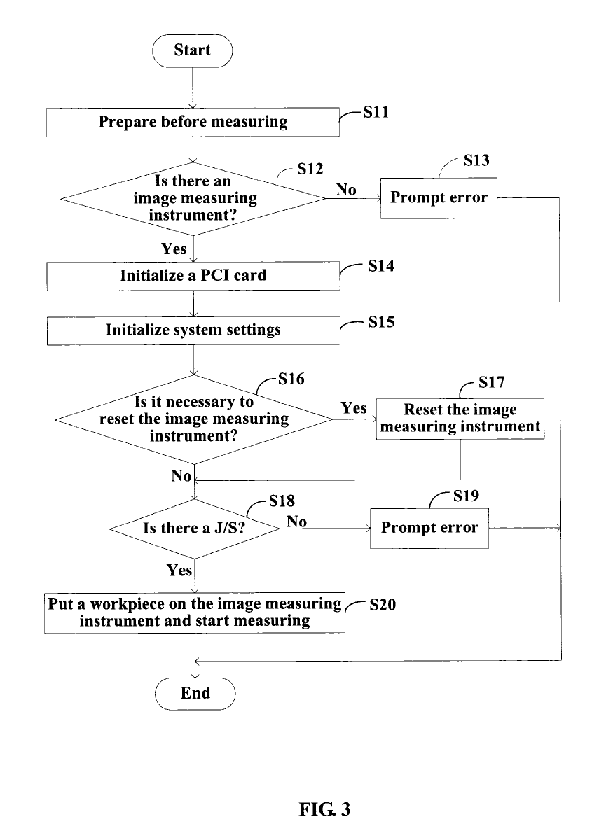

FIG. 3 is a flowchart of a method for preparing image measuring in accordance with one preferred embodiment. In Step S11 preparations are made before measuring that involve: connecting the CCD 210 with the PCI card 102, connecting the motor controller 230 with the first I/F 104, connecting the lens motor controller with the second I/F 106, and connecting the J/S 110 with the third I/F 108.

In step S12, the image measuring unit 130 detects whether the image measuring instrument 20 is connected appropriately.

In step S13, if the image measuring instrument 20 is not connected, or if the image measuring instrument 20 is not connected appropriately, the image measuring unit 130 prompts an error correspondingly, and then the procedure ends.

In step S14, if the image measuring instrument 20 is connected appropriately, the image measuring unit 130 initializes the PCI card 102 for acquiring images.

In step S15, the image measuring unit 130 initializes system settings. Specifically, the image measuring unit 130 sets identifications of structural patterns of an image to be measured and a predetermined contrast value.

In step S16, the image measuring unit 10 detects whether the image measuring instrument 20 needs to be reset.

In step S17, if the image measuring instrument 20 needs to be reset, resets the image measuring instrument 20.

In step S18, the image measuring unit 130 detects whether there is a J/S 110 connected.

In step S19, if the J/S 110 is not connected, the image measuring unit 130 prompts an error correspondingly, and then the procedure ends.

In step S20, if there is a J/S 110, the workpiece is placed on the image measuring instrument 20, and the measuring instrument 20 starts measuring the workpiece.

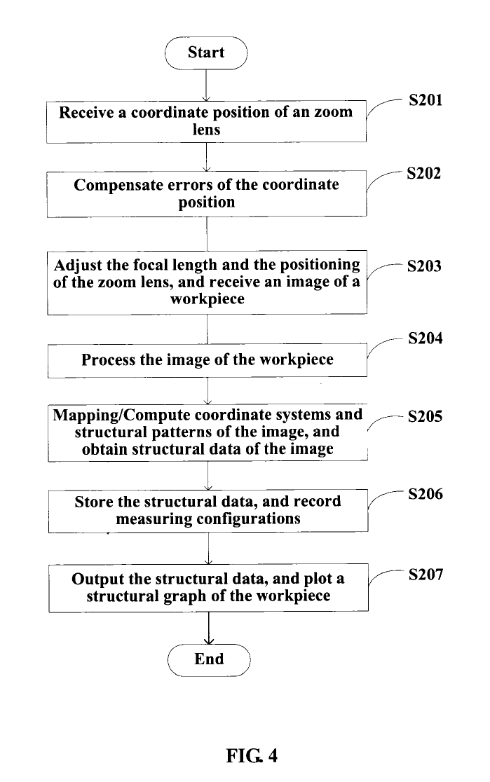

FIG. 4 is a flowchart of a method for image measuring in accordance with one preferred embodiment. In step S201, the data receiving module 131 receives a coordinate position of the zoom lens 220 via the first I/F 104.

In step S202, the accuracy compensating module 132 compensates any errors of the coordinate position.

In step S203, the image measuring unit 130 adjusts the focal length and the positioning of the zoom lens 200, and the data receiving module 131 receives an image of the workpiece on the image measuring instrument 20 via the PCI card 102. Specifically, the image measuring unit 130 sends zoom instructions to the zoom lens motor controller 250, the zoom lens motor controller 250 then adjusts the focal length of the zoom lens 220 corresponding to the zoom instructions. The image measuring unit 130 sends move instructions to the motor controller 230 by operating the J/S 110, the motor controller 230 then adjusts the positioning of the zoom lens 220 corresponding to the move instructions. Wherein, the move instructions include positioning and speeds.

In step S204, image processing module 133 processes the image of the workpiece. Specifically, the image processing module 133 identifies outlines of the image via an edge tool, analyzes the structural patterns of the outlines that include spot, line, circle, and plane, filters the outlines smoothly via a filter tool, and computes a sharpness of the image.

In step S205, the computing module 134 maps/computes coordinate systems and structural patterns of the image, and obtains structural data of the image. Specifically, the computing module 134 uses a mechanical coordinate system of the image measuring instrument as a reference coordinate grid, and maps coordinate systems selected by an operator according to the coordinate grid, computing spatial locations of structural patterns of the image, and computing relative coordinates between two different structural patterns of the image. Wherein, the structural data include coordinates of the image, a geometrical shape of the image, and a unit vector of the image.

In step S206, the storing module 135 stores the structural data of the image in a program file, and the code recording module 136 records measuring configurations with corresponding procedure codes while measuring the workpiece. Wherein, the measuring configurations include a positioning coordinates of the zoom lens 220, a positioning speed of the zoom lens 220, and other related operational information such as an edge tool, a focus tool, measuring elements, constructive elements, and coordinates.

In step S207, the outputting module 137 outputs the structural data of the image, and the graph plotting module 138 plots a structural graph of the workpiece based on the structural data of the image. Wherein, the structural graph of the workpiece may include coordinates of the image, structural patterns of the image, and identifications of structural patterns of the image.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for image measuring, the system comprising:
a data receiving module for receiving a coordinate position of a zoom lens on an image measuring instrument connected to a computer, and for receiving an image of a workpiece on the image measuring instrument;
an accuracy compensating module for compensating errors of the coordinate position of the zoom lens;
an image processing module for processing the image of the workpiece;
a computing module for mapping/computing coordinate systems and structural patterns of the image, and obtaining structural data of the image; and
an outputting module for outputting the structural data of the image.

2. The system according to claim 1, further comprising a storing module for storing the structural data of the image.

3. The system according to claim 1, further comprising a code recording module for recording measuring configurations with corresponding procedure codes while measuring the workpiece.

4. The system according to claim 1, further comprising a graph plotting module for plotting a structural graph of the workpiece based on the structural data of the image.

5. The system according to claim 1, wherein the image processing module processes the image of the workpiece by: identifying outlines of the image via an edge tool; analyzing the structural patterns of the outlines; filtering the outlines smoothly via a filter tool; and computing a sharpness of the image.

6. The system according to claim 1, wherein the computing module computes the coordinate systems by: using a mechanical coordinate system of the image measuring instrument as a reference coordinate grid, and mapping coordinate systems selected by an operator according to the coordinate grid.

7. The system according to claim 1, wherein the computing module computes the structural patterns of the image by: computing spatial locations of structural patterns of the image, and computing relative coordinates between two different structural patterns of the image.

8. The system according to claim 1, wherein the structural data include coordinates of the image, a geometrical shape of the image, and a unit vector of the image.

9. The system according to claim 1, wherein the measuring configurations comprise a positioning coordinates and a positioning speed of the zoom lens, an edge tool, a focus tool, measuring elements, constructive elements, and coordinates.

10. A computer-based method for image measuring, the method comprising the steps of:
providing a workpiece on an image measuring instrument connected to a computer;
receiving a coordinate position of a zoom lens on the image measuring instrument;
compensating errors of the coordinate position;
adjust the focal lengths and positioning of the zoom lens, and receiving an image of the workpiece;
processing the image of the workpiece;
mapping/computing coordinate systems and structural patterns of the image, and obtaining structural data of the image; and
outputting the structural data of the image.

11. The method according to claim 10, further comprising the step of storing the structural data of the image, and recording measuring configurations with corresponding procedure codes while measuring the workpiece.

12. The method according to claim 10, further comprising the step of plotting a structural graph of the workpiece based on the structural data of the image.

13. The method according to claim 10, wherein the step of processing the image of the workpiece comprises:
identifying outlines of the image via an edge tool;
analyzing the structural patterns of the outlines;
filtering the outlines smoothly via a filter tool; and
computing a sharpness of the image.

14. The method according to claim 10, wherein the step of computing coordinate systems and structural patterns of the image, and obtaining structural data of the image comprises:
using a mechanical coordinate system of the image measuring instrument as a reference coordinate grid;
mapping coordinate systems selected by an operator according to the coordinate grid;
computing spatial locations of structural patterns of the image; and
computing relative coordinates between two different structural patterns of the image.

15. The method according to claim 10, wherein the structural data include coordinates of the image, a geometrical shape of the image, and a unit vector of the image.

16. The method according to claim 10, wherein the measuring configurations comprise a positioning coordinates and a positioning speed of the zoom lens, an edge tool, a focus tool, measuring elements, constructive elements, and coordinates.
